(19) United States
(12) Patent Application Publication
(10) Pub. No.: US 2013/0132125 A1
(43) Pub. Date: May 23, 2013

(54) SYSTEM AND METHOD FOR PROVIDING INSURANCE

(71) Applicant: John L. Baeke, Overland Park, KS (US)

(72) Inventor: John L. Baeke, Overland Park, KS (US)

(21) Appl. No.: 13/736,057

(22) Filed: Jan. 7, 2013

Related U.S. Application Data
(63) Continuation-in-part of application No. 12/622,319, filed on Nov. 19, 2009, now abandoned.

(51) Int. Cl. G06Q 40/08; G06Q 50/22

(52) U.S. Cl. CPC G06Q 40/08; G06Q 50/22
USPC 705/4

(57) ABSTRACT

A system and method for providing post-operative insurance in a surgical procedure involving implantation of a foreign material into a human body includes underwriting an insurance policy to cover an adverse event resulting from the procedure that may occur from a completion date of the procedure up to at least one year from the completion date of the procedure from a completion date of the procedure. The method further includes determining eligibility for enrollment of a patient undergoing the procedure and providing the insurance policy to the patient if the patient is eligible to enroll. Upon receiving a policy claim for the event, the claim is evaluated and insurance coverage is provided for the patient if the event is covered by the policy.

### CROSS-REFERENCE TO RELATED APPLICATIONS

This application is a continuation-in-part of application Ser. No. 12/622,319, filed on Nov. 19, 2009 now pending, entitled SYSTEM AND METHOD FOR PROVIDING INSURANCE.

### FIELD

The present invention relates to a system and method for providing insurance, and more particularly, to a system and method for providing insurance related to surgical procedures utilizing implants, prostheses or artificial devices which have both near-term and late-term health-related implications.

### BACKGROUND

Presently, manufacturers' warranties (e.g., Confidence Plus Platinum) and health insurance (e.g., CosmetAssure®) represent the only financial protection available to the breast augmentation patient. As these plans do not cover the most common problems associated with breast augmentation surgery; and are of short duration (30 days for CosmetAssure®), they are not popular with most patients. Further, as they do not compensate the surgeon for professional fees, they are not popular with physicians. Implant surgery, especially breast augmentation, is a unique operation, among most cosmetic surgical procedures. It is unique because of the dynamics of its complication occurrence rate. The occurrence of complications in the breast augmentation patient may be reflected by a bi-modal distribution (two separate peaks plotted over time). Understanding this dynamic is important for any insurance plan to be designed efficiently, effectively and fiscally solvent.

The first peak is primarily comprised of hematoma/seroma, implant malposition, asymmetry, wound healing problems, infection, size/style change and general dissatisfaction while the second broader peak is made up of primarily capsular contracture, ptosis repair, implant malposition, biopsy and implant leakage/rupture. Again, as current insurance plans and warranties typically do not reimburse the plastic surgeon for his/her services, physicians typically are not motivated to promote the product to their patients.

Patients desire an affordable insurance plan which will truly address their fears of spiraling costs from a succession of complications and re-operations that may be necessary following implant surgery. Patients desire a plan which will cover almost every eventuality, near-term and late-term, and at an affordable price. Surgeons desire an insurance plan which will fairly compensate them for their professional services, rather than demand they treat the patient for free or reduced cost.

### SUMMARY

A system and method for providing insurance to cover aesthetic side effects of elective cosmetic surgeries is provided. Further, a system and method for providing complications insurance, including insurance for the breast augmentation patient, is disclosed. With most other plastic or cosmetic operations not utilizing implants (e.g., liposuction) few, if any, complications related to the procedure occur beyond the 30-day post-op window. Thus, there is no need for a long-term insurance policy covering these procedures.

However, such is not the case with the unique situation of implant surgery utilizing breast implants or tissue expanders (as well as, buttock; pectoral; calf; facial; cranial, ophthalmic/ocular, auditory, dental, respiratory, cardiovascular, genitourinary, spinal, gastrointestinal, bariatric, orthopedic, pharmaceutical etc. implants and soft tissue fillers). Here one sees a slowly progressive increase in the incidence of complications with years. The system and method may cover near-term and late-term complications. For device defects such as implant rupture, it may cover those usual and customary fees not provided by the manufacturer's warranty.

The reoperative expense associated with more common early complications (e.g., hematoma/seroma evacuation) is typically much less than the more costly late term complications (i.e., capsular contracture). However, it is the second peak corresponding to late-term complications, which will keep the member and/or manufacturer committed to the system and method.

### BRIEF DESCRIPTION OF THE DRAWINGS

FIG. 1 illustrates a bi-modal distribution plot overtime of the occurrence of complications in a breast augmentation patient.

FIGS. 2A-2F illustrate steps in a method illustrative of the present method.

FIG. 3 illustrates a preferred method of underwriting an insurance policy to cover an adverse event resulting from a surgical procedure involving implantation of a foreign material into a human body that may occur from a completion date of the procedure up to at least one year from the completion date of the procedure.

FIG. 4 illustrates a preferred method of providing post-operative insurance for a surgical procedure involving implantation of a foreign material into a human body.

FIG. 5 illustrates a preferred method of providing post-operative insurance for a breast augmentation procedure.

FIG. 6 illustrates a preferred method of monitoring health and aesthetic complications of a patient post-surgical procedure in order to maintain the patient's eligibility for continued coverage in a long term insurance policy for the procedure.

FIG. 7 illustrates a preferred method of determining prices for insurance coverage for a surgical procedure involving implant removal.

### DETAILED DESCRIPTION OF PREFERRED EMBODIMENTS

Each year, over 1 million patients worldwide seek breast augmentation surgery. One common concern cited by patients considering breast augmentation surgery is the fear of costly complications and reoperations. In the United States alone over 380,000 breast augmentation procedures were estimated to have been performed in 2006. Breast augmentation is now the most commonly performed cosmetic operation in the United States. This represents an 868% increase from 1992. With this increase comes an increase in the number of health-related issues associated with breast augmentation, both near-term and late-term.

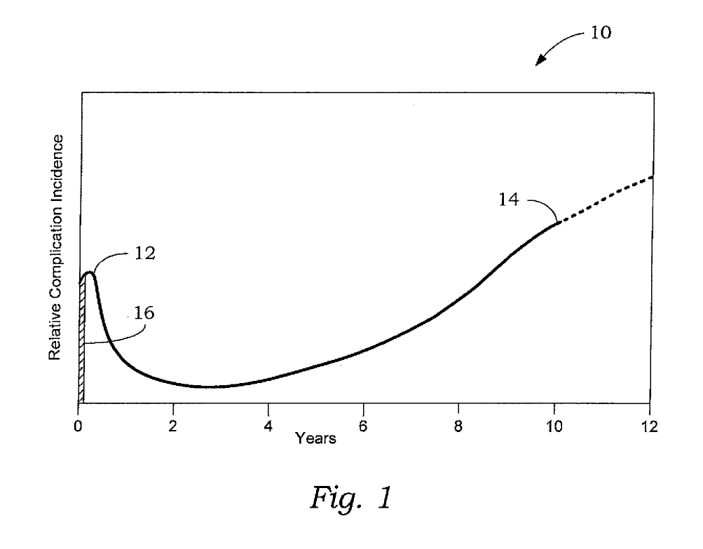

Referring initially to FIG. 1, breast augmentation is a unique operation, among most cosmetic surgical procedures. It is unique because of the dynamics of its complication occurrence rate. Plotted over time, the occurrence of complications in the breast augmentation patient is reflected by a bi-modal distribution 10. Understanding this dynamic is important for any insurance plan to be efficient, effective and fiscally solvent.

The first peak 12 is primarily comprised of hematoma/seroma, implant malposition, asymmetry, wound healing problems, infection, size/style change, anaesthesia complications and general dissatisfaction with the results of the procedure, for example. The second broader peak 14 is made up of primarily capsular contracture, ptosis repair and deflation.

The present invention is a system and method for insurance designed for the breast augmentation patient, but may likewise be applied to cover other operations utilizing implants or prostheses with a similar progressive bi-modal complication occurrence rate. Typically with other cosmetic operations (e.g., liposuction) few, if any complications occur beyond the 30-day post-operative window 16. Thus, an insurance policy that covers complications years after the operation is not practical for the typical cosmetic surgery patient.

However, such is not the case with the unique situation of patients receiving implants, most notably breast augmentation. Here one sees a slowly progressive increase 14 in the incidence of complications over a period of years. The present system and method may cover minor and major complications which may be predicted by the bi-modal distribution 10. Coverage benefits might include: in-patient hospitalization; ambulance transfer; out-patient surgery; diagnostic imaging and laboratory studies; infection; implant malposition; diagnosis and treatment of deep venous thrombosis, pneumothorax, implant rupture, capsular contracture, adverse reaction, hematoma/seroma, chronic pain, poor wound healing, anaesthetic complications, general unhappiness, etc. Initial evaluation to study implant associated connective tissue, autoimmune, rheumatological disease would potentially be included. Other conditions such as ptosis repair (sagging), biopsy and/or style/size change may also be covered. For a problem related to a device defect such as an implant rupture, the present system and method may cover those usual and customary fees not provided by the manufacturer's warranty. Here the plan may provide coverage after warranty benefits are paid. If the rupture is determined to be iatrogenic by manufacturer's analysis, for example, the plan may pay surgery center and anesthesia fees, and optionally surgeon fees.

The reoperative expense associated with more common early complications (e.g., hematoma/seroma evacuation) is typically much less than the more costly late term complications (i.e., capsular contracture).

Though neither the manufacturer nor the Food and Drug Administration (“FDA”) have published any guidelines recommending routine breast implant replacement, discussions within the FDA advisory panels and the manufacturers strongly suggest a device life expectancy, in vivo, of at least 10 years. Thus, a policy with a term of 4 to 20 years is likewise proposed. Policies covering different types of devices might require different term length and benefits.

Studies have shown a higher complication and reoperation rate within the revision and reconstruction patient populations, than the primary breast augmentation population. Thus different rates may be applied based on these factors. Other factors may include saline versus silicone gel implants. Ideally, enrollment should be completed prior to surgery, with an effective date/time being the induction of anesthesia.

Ideally, all implant surgery should be in accordance with manufacturer's published guidelines and performed by physicians possessing current certification of training or licensure, in an accredited or federally certified surgery center or hospital. A grace period may be contemplated allowing enrollment for a limited period of time post-implantation, however, in those cases, the policy may not be retroactive. It may be contemplated that receiving replacement implant(s) during the term of member's policy, may restart the coverage period. Alternatively, the member may continue to be covered under terms of the original policy. A coverage period of less time may occur if (a) both implants are explanted and not replaced; or (b) for nonpayment of premiums. Processing of claims and benefit payments may be managed by a third party administrator (TPA).

Typically, surgeon, anesthesia, surgery center, hospital, laboratory and consultant's fees may be paid using conventional code-driven mechanisms and at a regionally adjusted, usual and customary schedule, or percentage thereof. Certain facility/hospital benefit caps or flat rates may also apply.

Premiums may be paid directly by the patient; or alternatively by the surgeon (embedded in the overall cost of surgery); or by the implant manufacturer (possibly embedded in the cost of the implant).

Table 1 below shows the 4-year complication rate by patient for the indicated complications. This table is an example of complications, and specifically for breast implant complications. However, this type of complications table is readily available for other types of implant surgery such as buttock; pectoral; calf; facial; cranial, ophthalmic/ocular, auditory, dental, respiratory, cardiovascular, genitourinary, spinal, gastrointestinal, bariatric, orthopedic, pharmaceutical etc. implants and soft tissue fillers, for example.

TABLE 1¹
Primary Augmentation: Complications
N = 455

| | 4-Year Complication Rate |
|---|---|
| Complication* | by Patient |
| Reoperation | 23.5% |
| Capsular Contracture III/IV | 13.2% |
| Breast Pain | 8.2% |
| Swelling | 7.8% |
| Implant Removal with Replacement | 7.5% |
| Nipple Complications | 4.9% |
| Implant Malposition | 4.1% |
| Scarring/Hypertrophic Scarring | 3.7% |
| Asymmetry | 3.2% |
| Implant Rupture (MRI cohort)** | 2.7% |
| Implant Removal without Replacement | 2.3% |
| Hematoma | 1.6% |
| Ptosis (sagging) | 1.4% |
| Breast/Skin Sensation Changes | 1.4% |
| Seroma/Fluid Accumulation | 1.3% |
| Bruising, Delayed Wound | <1% |
| Healing, Extrusion of Intact | |
| Implant, Infection, Redness, Skin Rash, | |
| Tissue/Skin Necrosis, Wrinkling Capsule | |
| Calcification, Irritation, Lymphadenopathy, | |
| Lymphedema, Other Complications, | |
| Pneumothorax | |

¹Data from Manufacturer's (Allergan, Inc., Irvine, CA) FDA Core Study.

Table 2 below provides the main reason for each reoperation performed through four years in primary augmentation patients. The most common reason for reoperation through four years in primary augmentation patients was because of capsular contracture (39 of 135 reoperations).

TABLE 2²
Primary Augmentation: Main Reason for Reoperation through
Four Years

| Reason for Reoperation | N |
|---|---|
| Capsular Contracture | 39 |
| Implant Malposition | 21 |
| Ptosis (sagging) | 19 |
| Need for Biopsy | 12 |
| Hematoma/Seroma | 9 |
| Scarring/Hypertrophic Scarring | 8 |
| Patient Request for Style/Size Change | 7 |
| Suspected Rupture | 6 |
| Asymmetry | 5 |
| Delayed Wound Healing | 3 |
| Breast Cancer, Extrusion of Intact Implant, | 1 each |
| Infection, Necrosis, Nipple Complications, | |
| Breast Pain | |
| Total | 135 |

²Data from Manufacturer's (Allergan, Inc., Irvine, CA) FDA Core Study.

The main reasons for implant removal among primary augmentation patients over the four years are shown in Table 3 below. There were 77 implants removed in 41 patients. Of these 77 implants, 60 were replaced. The most common reason for implant removal was capsular contracture (27 of the 77 implants removed).

TABLE 3
Primary Augmentation: Main Reason for Implant Removal through
Four Years

| Reason for Reoperation | N |
|---|---|
| Capsular Contracture | 27 |
| Patient Request for Style/Size Change | 18 |
| Implant Malposition | 9 |
| Suspected Rupture | 7 |
| Ptosis (sagging) | 6 |
| Asymmetry | 5 |
| Breast Pain | 2 |
| Breast Cancer, Hematoma/Seroma, Extrusion | 1 each |
| Of Intact Implant | |
| Total | 77 |

Implant manufacturers are challenged with the task of device tracking and complication monitoring. In the situation of breast implants, data is to be accumulated and submitted for the ongoing FDA post-approval study (silicone only). However, not all patients are enrolling in these studies. Not all physicians are compliant. Patient enrollment in the plan may be preconditioned upon the patient agreeing to conform with post-approval studies and continuing required surveillance/monitoring. This could be assured by (a) eligible health care benefits for significant reportable events would only be paid by the plan, predicated upon proper claim and medical record submission to the plan (and then forwarded to the manufacturer or other monitoring body). Further, (b) a key requirement of the post-approval study is routine MRI evaluations at years three, five, seven and nine. If these studies are paid for by the patient, it may be anticipated that compliance with this critical portion of the study would be low. In one coverage option, the plan would pay for these imaging studies to member patients, and the member would authorize release of results to manufacturer and/or FDA and/or other surveiling body (fee contracting with imaging centers anticipated).

This is a low cost insurance plan. It is simple to understand and simple to administer with possibly no co-pays, no deductibles and no limited provider network. Most every eventuality may be covered. Now the patient is no longer going to be angry at the surgeon for suggesting that the patient owes more fees when an unforeseen complication occurs.

Surgeons may embrace this insurance plan and promote it to their patients because the plan provides for certain benefits to be paid to the surgeon when complications arise. No longer will the surgeon be placed in the sometimes volatile position of informing the patient that the patient owes more money for correction of a complication, of which the surgeon was not responsible. Payments to providers will be made promptly by the plan. However, to remove any inducement to defraud the plan with false claim submission by a few unscrupulous providers, certain checks may need to be instituted: e.g. (1) a preauthorization/predetermination/pre-certification process; (2) claim review; (3) medical record audit on request; (4) coverage limits on professional fees.

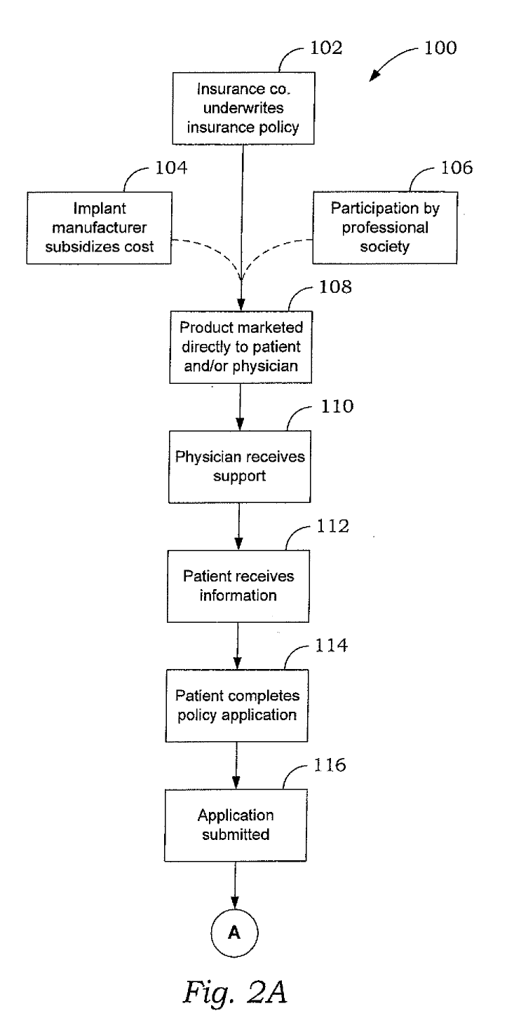

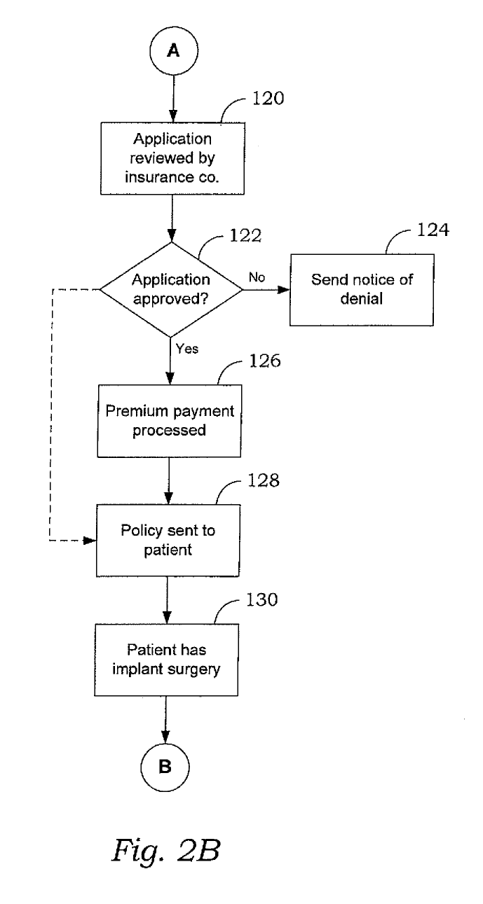

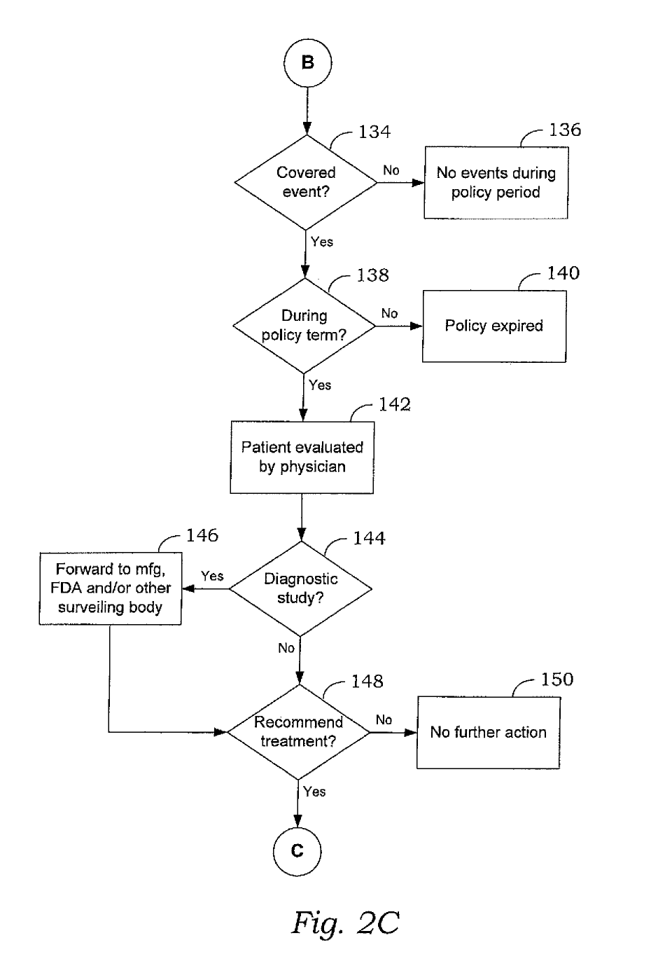

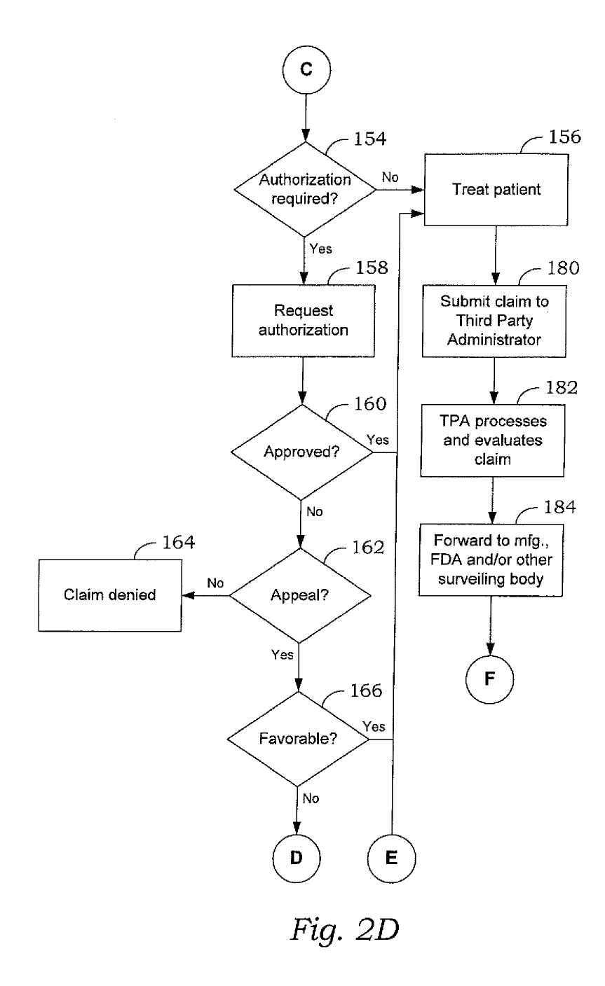

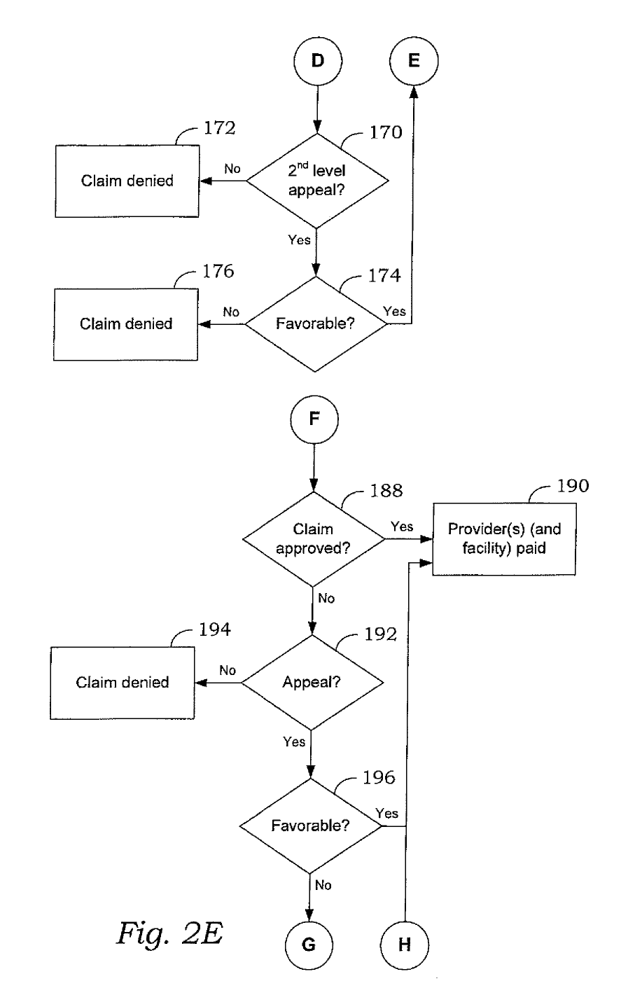

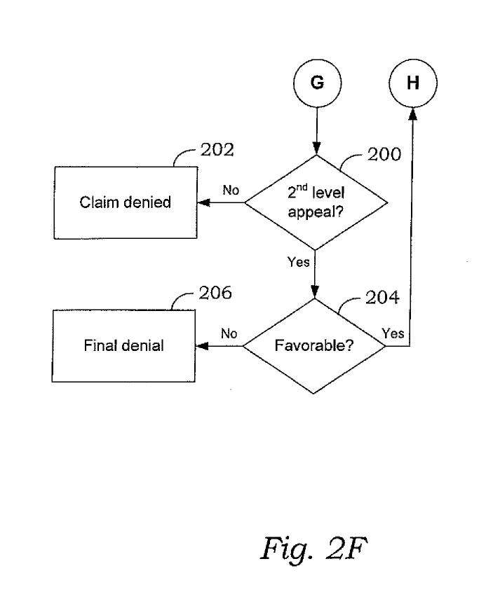

Referring to FIGS. 2A-2F a method of the present invention is generally indicated by reference numeral 100. The process 100 begins with an insurance company underwriting an implant insurance policy 102. Optionally an implant manufacturer may subsidize the cost 104 and/or a professional medical society may participate in the plan 106. The policy may be marketed directly to the patient receiving the implant and/or the physician performing the surgery 108. The physician may receive support and training on possible marketing, processing of implant insurance applications and implementation of the policy 110. The patient receives informational materials 112 and if interested completes policy application 114. The completed application is submitted to the insurance company 116.

Next, the application is reviewed by the insurance company 120. If the application is not approved 122, a notice of denial is sent to the applicant 124. If the application is approved 122, a full premium payment (or deposit) is processed by the insurance company 126, unless paid on behalf of the patient by manufacturer or other third party. Optionally, the policy may be automatically issued with the premium paid by the manufacturer. The policy and handbook may be sent to the patient 128. Thereafter, the patient has the implant surgery 130.

If no covered events occur 134, then the policy simply expires 136. If a covered event occurs 134, but it is not during the policy term 138, then no additional action is taken 140. If a covered event occurs 134, during the policy term 138, the patient is evaluated by a physician or surgeon 142. If diagnostic studies are obtained 144, the results may be forwarded to the manufacturer and/or Food and Drug Administration (FDA) or other surveiling body 146. Otherwise, if treatment is not recommended 148, then no further action is taken 150.

If treatment is recommended 148, then authorization is determined per the insurance company's policy and protocol. If no authorization is required 154, then the patient is treated 156. If authorization is required 154, then a request or claim is submitted by the physician to the insurance company or third-party administrator (TPA) for pre-authorization, predetermination and/or pre-certification of surgery 158. If the request is authorized 160, the patient is treated 156. If authorization is denied 160, then the patient may appeal 160. If no appeal is timely filed, then the claim is finally denied 164. If the denial is appealed 162, and the review by the TPA or other reviewer is favorable 166, the patient is treated 156. If the appeal is not favorable 166, a second level appeal may be submitted 170.

If the second level appeal 170 is not requested, then the claim is finally denied 172. If the second level appeal is requested, and the review is favorable 174, the patient is treated 156. If not, the claim is finally denied 176. If the patient is treated 156 according to the recommendations of the physician or surgeon, code-driven claim(s) may be submitted by the provider(s) and facility to the TPA 180, which may include supporting records. The TPA processes and evaluates the claim 182 and forwards the reportable event data to the implant manufacturer, FDA and/or other surveiling body 184. If the TPA approves the claim 188, the provider is paid in accordance with the policy terms and benefits 190. If the claim is denied by the TPA 188, the patient or provider may appeal the claim denial 192. If no appeal is submitted then the claim is finally denied 194. If the claim is appealed 192 and the review is favorable 196, then the provider is paid 190. If the review is not favorable 196, a second level appeal may be submitted 200. If no second level appeal is filed, then the claim is finally denied 202. If the review of the second level appeal is favorable 204, then the provider is paid 190. If the review is not favorable 204, then the claim is finally denied 206.

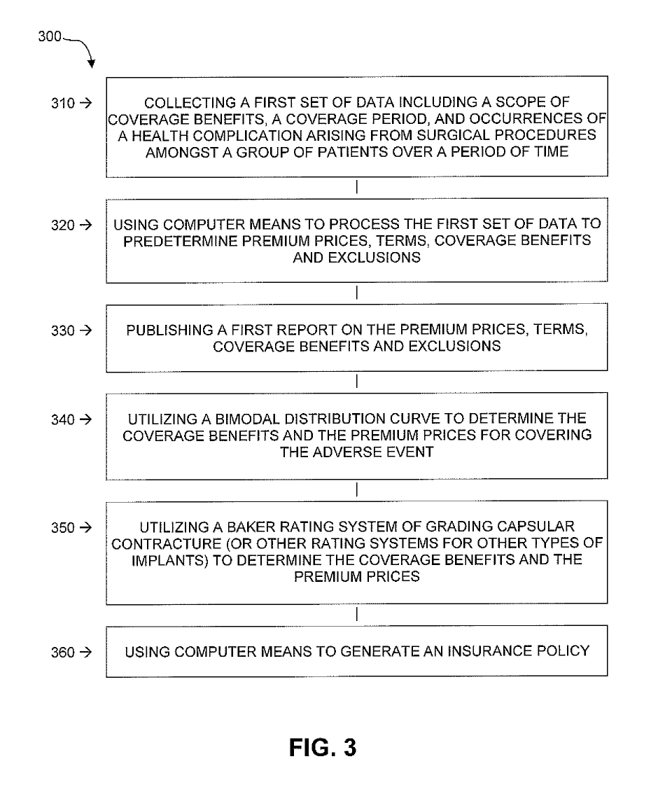

FIG. 3 illustrates a preferred method 300 of underwriting an insurance policy to cover an adverse event resulting from a surgical procedure involving an implantation of a foreign material into a human body that may occur from a completion date of the procedure up to at least one year from said completion date. In the preferred embodiment, the insurance policy may comprise a multi-year policy covering adverse events up to ten years or more from the procedure date, subject to any required policy renewals (e.g., annual renewals). In particular, the preferred method 300 uniquely comprises underwriting insurance to cover long-term discomfort, aesthetic/cosmetic complications and/or health complications that may result from the intentional introduction of a foreign object into a patient's body via surgery. Such may include surgeries utilizing breast, bone, buttock, pectoral, calf, facial, cranial, ophthalmic/ocular, auditory, dental, respiratory, cardiovascular, genitourinary, spinal, gastrointestinal, bariatric, orthopedic, pharmaceutical implants and soft tissue fillers. Examples of these surgeries may include augmentation and reconstruction breast implants and expanders, fixation plates, male pectoral augmentation, calf augmentation, cheek, nose and chin implants, titanium plates, gold implants for eyelid palsy, implantable hearing devices, osteointegrated dental implants, pacemakers, heart valves, prosthetic testes and penile implants, shunts, bariatric implants, various medicine delivery devices such as for insulin, birth control, etc., and calcium hydroxylapatite.

The method 300 comprises step 310 of collecting a first set of data including a scope of coverage benefits, a coverage period, and occurrences of a health complication arising from surgical procedures such as breast augmentation procedures amongst a group of patients over a period of time. As mentioned above, to devise a fiscally solvent insurance plan that is affordable, yet covers almost every possibility of an adverse event following a breast augmentation procedure, whether near term or late term, various factors must be collected and taken into account. For this purpose, the bi-modal distribution curve shown in FIG. 1 and the associated data may be utilized.

As illustrated in FIG. 1, immediately after the completion date of the procedure, there are high incidences of health and aesthetic/cosmetic complications such as hematoma/seroma, implant malposition, asymmetry, wound healing problems, infection, size/style remorse, anaesthesia complications and general dissatisfaction with the results of the procedure. These incidences rapidly decline thereafter until approximately two years after the completion date of the procedure. This is shown as the first peak 12 of the bi-modal distribution curve. Beginning in the second year after the completion date of the procedure, incidences of health complications, particularly the more serious conditions such as capsular contracture, ptsosis, implant deflation and rupture, begin to slowly rise again over time without any possibility of a downward reverse for a second time. This is shown as the second broader peak 14 of the bi-modal distribution curve. Therefore, the preferred insurance policy described herein covers occurrences of health complications beyond two years from the completion date of the procedure.

In the example of a breast augmentation, the data on the various health complications and their occurrences are tabulated in Tables 1-3 above. As illustrated in Tables 1-3, the data were collected over a number of years (i.e., four years) on a group of patients who underwent breast augmentation surgeries. The data related to coverage benefits may include in-patient hospitalization, ambulance transfer, out-patient surgery, diagnostic imaging and laboratory studies, initial evaluation, breast implant replacements, breast implant removal upon request of the patient, and reoperative procedures. Other data related to coverage benefits may further include the dollar limits on physician's professional fees, anaesthesia fees and facility fees and their respective policy caps pertaining to each health complication.

After the first set of data is collected, step 320 comprises using computer means to process the first set of data to predetermine premium prices, terms, coverage benefits and exclusions. By way of example and not as a limitation, raw data pertaining to various types of health complications and their occurrences, coverage benefits and coverage periods may be collected and stored into a first centralized electronic database. A computer software may be provided to allow these variables to be inputted and subsequently processed according to certain predetermined parameters to generate various insurance policies or a specifically tailored insurance policy. For example, by providing a certain cap on the premium price, the computer may predetermine the prices, scopes of coverage benefits and exclusions included in a certain type of policy. Alternatively, by only choosing coverage for certain health complications, the computer may generate a list of optional premium prices available to the patient. The information stored in the centralized database may be edited, saved, deleted, accessed and processed by multiple computers. Furthermore, the same aforementioned database will allow more efficient transmittal of implant performance/complication outcome data to private and professional surveilling organizations, scientific researchers and the Food & Drug Administration and other governmental regulatory agencies as required by the governing codes, statutes and regulations.

Additionally, a computer program may be utilized to analyze and produce actuarial and statistical methods to evaluate what portion of the group of patients studied will seek an operation if those patients are eligible for enrollment in a policy.

Subsequently, step 330 further comprises publishing a first report on the premium prices, terms, coverage benefits and exclusions. For example, the first report may be printed, emailed or accessed using a secure log in system by insurance agents or insurance clients on a website or smartphone mobile application.

As mentioned above, method 300 may comprise step 340 of utilizing a bimodal distribution curve to determine the coverage benefits and the premium prices for covering the adverse event. In another preferred method, step 350 may further comprise utilizing a Baker rating system of grading capsular contracture or other rating systems for other types of implants to determine the coverage benefits and the premium prices.

Capsular contracture is an abnormal or hyperreactive response of the human physiological system to foreign materials in the human body occurring mostly in the context of complications and side effects from surgically placed implants, prostheses and the like. In the example of breast enhancement surgery, capsular contracture is a consequence of a progressive development of fibrous scar tissue encapsulating the breast implant.

The occurrence of capsular contraction follows the formation of tightly-woven collagen fibers, created by the physiological response to the presence of foreign objects surgically installed to the human body, e.g. breast implants, artificial pacemakers and orthopedic prostheses. Capsular contracture occurs when the collagen-fiber fibrous capsule increases in thickness, tightens and squeezes the breast implant; as such, it is a medical complication that can be very painful and discomforting, and might distort the aesthetics of the breast implant and the breast. Factors common to its incidence include bacterial contamination, rupture of the breast-implant shell, leakage of the silicone-gel filling and hematoma.

The Baker rating system is one of the industry accepted standards in measuring the degree of capsular contracture. The Baker rating system uses a scale of four grades to grade the firmness of a woman's breast following a breast augmentation procedure:

Grade I—the breast is normally soft and appears natural in shape

Grade II—the breast is a mildly firm

Grade III—the breast is firm and often appears abnormal

Grade IV—the breast is hard, painful to the touch and typically appears abnormal

Finally, step 360 may further comprise using computer means to determine pricing for such an insurance policy covering health complications resulting from implant procedures, particularly implants for aesthetics purposes. According to one preferred embodiment, a policy issued may be for a term of at least one year, extendable for longer terms either by the patient's request or by a mutual agreement between an insurance provider and an insured. In another embodiment, a term of 4 to 20 years from the completion date of the procedure may be issued.

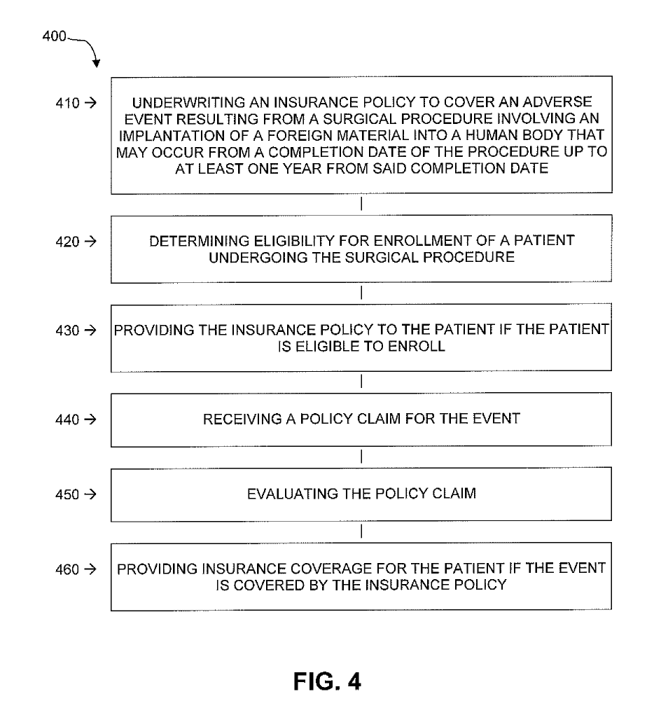

FIG. 4 illustrates a preferred method 400 of providing post-operative insurance for a surgical procedure involving implantation of a foreign material into a human body. The method 400 comprises step 410 of underwriting an insurance policy to cover an adverse event resulting from the procedure that may occur from a completion date of the procedure up to at least one year from the completion date of the procedure, as described above in connection with FIG. 3 and identified as method 300, incorporated by reference herein. In the preferred embodiment, the insurance policy may comprise a multi-year policy covering adverse events up to ten years or more from the procedure date, subject to any required policy renewals (e.g., annual renewals).

Step 420 generally comprises determining eligibility for enrollment of a patient undergoing the procedure. Step 420 comprises collecting personal information on the patient and using computer means to process the patient's information against available insurance. For example, the patient's medical conditions may be inputted into a second centralized database, and a computer program may match the patient's specific health complications with the available insurance plans stored in the first centralized database to determine whether the patient is eligible to enroll in an insurance plan. According to one preferred method, step 420 may further include providing MRI evaluation coverage and preconditioning the patient to agree to undergo routine MRI evaluations over the period of time. In another preferred method, step 420 may further include preconditioning the patient to agree to authorize release of MRI evaluation results to a third party, such as the FDA, a breast implant manufacturer or any surveilling body.

Step 430 comprises providing the insurance policy to the patient if the patient is eligible to enroll. The insurance plan according to the present invention is available in one of three varieties: 1) either as a blanket policy offered to breast implant manufacturers covering all eligible individuals, 2) a policy offered directly to the patient, or 3) a policy offered to physicians providing the procedure. Accordingly, step 430 may further comprise providing a blanket policy to a breast implant manufacturer. Alternatively, step 430 may further comprise providing a policy to a physician providing the procedure.

Step 440 comprises receiving a policy claim for the event. Step 450 comprises evaluating the policy claim, which may include collecting a second set of data including information related to the event. According to one method, step 450 may further comprise analyzing whether the health complication related to the event falls under either Grade III or Grade IV of the Baker rating system.

Step 460 comprises providing insurance coverage for the patient if the event is covered by the insurance policy.

It will be appreciated that method 400 also comprises a preferred method of providing long-term post-operative insurance to patients who have undergone surgeries involving the introduction of a foreign object into the body, including surgeries utilizing breast, bone, buttock, pectoral, calf, facial, cranial, ophthalmic/ocular, auditory, dental, respiratory, cardiovascular, genitourinary, spinal, gastrointestinal, bariatric, orthopedic, pharmaceutical implants and soft tissue fillers. In particular, a preferred insurance product is provided for recipients of all types of implants and surgical objects who may suffer discomfort and/or health complications and or aesthetic/cosmetic complications over time as a result of the body reacting to the foreign object. As an example and not by way of limitation, the preferred insurance product and method of providing the same may be applicable to patients suffering the effects of scar tissue that has developed over time due to the surgical introduction of a foreign object into the body.

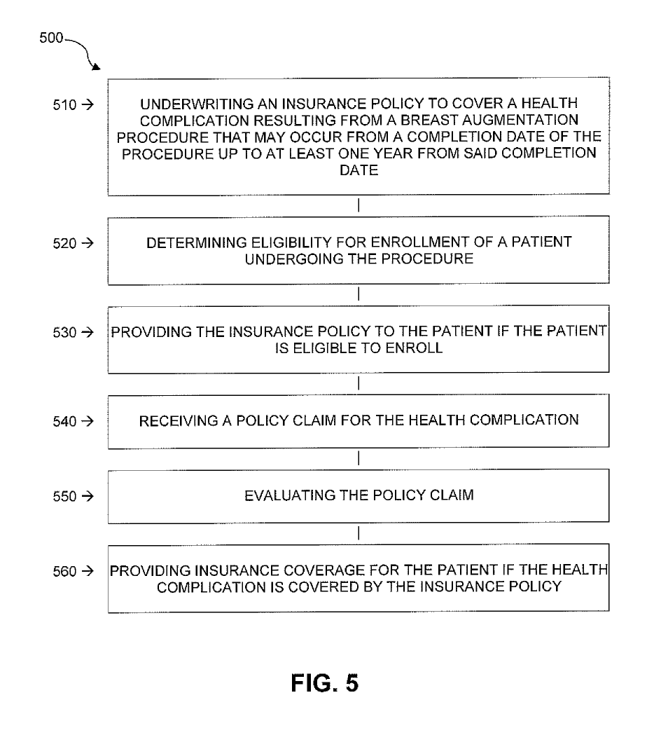

FIG. 5 illustrates a preferred method 500 of providing post-operative insurance for a breast augmentation procedure. The detailed description pertaining to the method 400 set forth above is fully applicable to the method 500 and incorporated by reference herein. The method 500 comprises step 510 of underwriting an insurance policy to cover a health complication resulting from the procedure that may occur from a completion date of the procedure up to at least one year from the completion date of the procedure as described above in connection with FIG. 3 and identified as method 300, incorporated by reference herein. In the preferred embodiment, the insurance policy may comprise a multi-year policy covering adverse events up to ten years or more from the procedure date, subject to any required policy renewals (e.g., annual renewals). According to a preferred embodiment, the health complication comprises a capsular contracture.

Step 520 generally comprises determining eligibility for enrollment of a patient undergoing the breast augmentation procedure, as described above in connection with FIG. 4 and identified as step 420, incorporated by reference herein. Step 530 comprises providing the insurance policy to the patient if the patient is eligible to enroll. Step 540 comprises receiving a policy claim for the health complication.

Step 550 comprises evaluating the policy claim, which may include collecting a second set of data including information related to the health and aesthetic complications. According to one preferred embodiment involving a capsular contracture, step 550 further comprises analyzing whether the capsular contracture falls under either Grade III or Grade IV of the Baker rating system.

Step 560 comprises providing insurance coverage for the patient if the health complication is covered by the insurance policy.

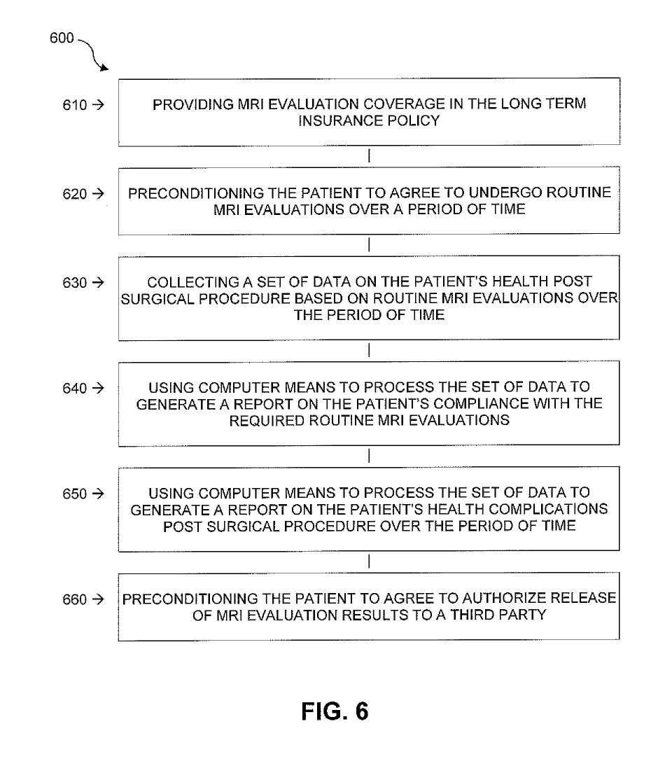

FIG. 6 illustrates a preferred method 600 of monitoring health and aesthetic complications of a patient post-surgical procedure in order to maintain the patient's eligibility for continued coverage in a long term insurance policy for complications resulting from the procedure. In the preferred embodiment, the procedure may comprise augmentation and reconstruction breast implants and expanders, fixation plates, male pectoral implants, calf augmentation, cheek, nose and chin implants, titanium plates, eyelid palsy implants, implantable hearing devices, osteointegrated dental implants, pacemakers, heart valves, prosthetic testes and penile implants, shunts, bariatric implants, various medicine delivery devices such as insulin, birth control, etc., and calcium hydroxylapatite. The method 600 comprises step 610 of providing MRI evaluation coverage in the long term insurance policy. Step 620 comprises preconditioning the patient to agree to undergo routine MRI evaluations over a period of time.

Step 630 comprises collecting a set of data on the patient's health and implant condition, post-surgical procedure, based on routine MRI evaluations over the period of time (as recommended by the Food & Drug Administration). Preferably, step 630 is taken at predetermined intervals over the period of time. According to one preferred method, the predetermined intervals may be set at 3 years, 5 years, 7 years, and 9 years from the completion date of the procedure.

Step 640 comprises using computer means to process the set of data to generate a report on the patient's compliance with the required routine MRI evaluations. For example, providers may store the MRI evaluation results in a centralized electronic database. Using a computer software, a report on the patient's compliance may be recorded in the same database and provided to a third party upon request, such as breast implant manufacturers or the FDA.

Alternatively, the method 600 may further comprise step 650 of using computer means to process the set of data to generate a report on the patient's health complications post-surgical procedure over the period of time in a similar manner to step 640 described above. Lastly, the method 600 may further comprise step 660 of preconditioning the patient to agree to authorize release of MRI evaluation results to a third party, such as the FDA, a breast implant manufacturer or other surveilling body.

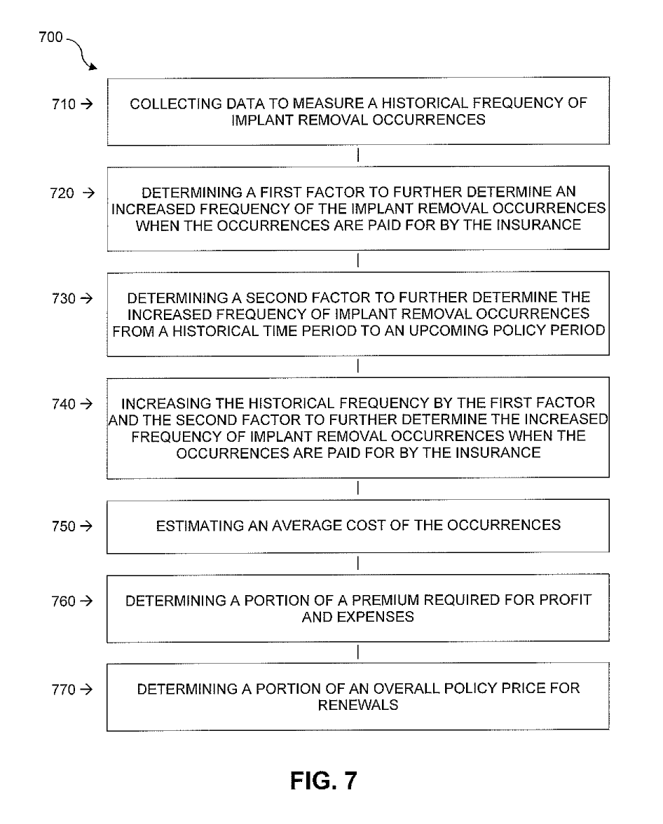

A method of determining prices for insurance coverage for a surgical procedure involving implant removal is also provided by the present invention. The actuarial analysis and statistical modeling required for removal of implant devices is particularly complex. While other insurance policies cover fortuitous events that arise from a variety of natural and man-made causes, coverage for removal requires the actuarial and underwriting evaluation of events and circumstances that are not considered insurable because they are not fortuitous. FIG. 7 illustrates a preferred method 700 of determining insurance coverage prices for implant removal, which may include the following steps below.

Step 710 comprises collecting data to measure a historical frequency of implant removal occurrences (N).

Step 720 comprises determining a first factor to further determine an increased frequency of the implant removal occurrences when the occurrences are paid for by insurance. In a preferred embodiment, this step further comprises determining a first factor (F) through clinical and behavioral research and analysis to determine the increased frequency of removal occurrences when the removal occurrences are paid for by the insurance.

Step 730 comprises determining a second factor to further determine the increased frequency of implant removal occurrences from a historical time period to an upcoming policy period. According to a preferred embodiment, this step further comprises determining a second factor (an annual trend factor T) through clinical and behavioral research and analysis to determine the increased frequency of removal occurrences from the historical time period to the upcoming policy period.

Step 740 comprises increasing N by F and T to determine the increased frequency of the occurrences when they are paid for by the insurance, wherein:
N_{adj}=F*N*T^{Y}, where Y=number of years from the average date of the historical time period to the average date of removal claim in the upcoming policy period being priced (This formula is used at times when research determines that trend changes compound exponentially over time)

or
N_{adj}=F*N*[T*Y] (This formula is used at times when research determines that trend changes compound additively over time);

Step 750 comprises estimating an average cost of the occurrences (C) either as a fixed policy benefit or through computer analysis of historical data and adjustments for inflation in surgical fees and medical expenses.

Step 760 comprises determining a portion of a premium E required for profit and expenses through actuarial analysis and consideration of management objectives and the competitive environment.

Lastly, step 770 comprises determining a portion of an overall policy price for renewals, Pᵣₑₘₒᵥₐₗₛ, according to the formula:

Pᵣₑₘₒᵥₐₗₛ=[N_{adj}*C]/[1−E].

Prices for other policy benefits can be determined through similar analytical and computer means.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements. The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method of providing post-operative insurance for a surgical procedure involving implantation of a foreign material into a human body, comprising:
underwriting an insurance policy to cover an adverse event resulting from the procedure that may occur from a completion date of the procedure up to at least one year from the completion date of the procedure further comprising:
collecting a first set of data including a scope of coverage benefits, a coverage period, and occurrences of a health and aesthetic complication arising from surgical procedures involving implantation of a foreign material into a human body amongst a group of patients over a period of time,
using computer means to process the first set of data to predetermine premium prices, terms, coverage benefits and exclusions, and
publishing a first report on the premium prices, terms, coverage benefits and exclusions;
determining eligibility for enrollment of a patient undergoing the surgical procedure, further comprising:
collecting personal information on the patient, and
using computer means to process the patient's information against available insurance;
providing the insurance policy to the patient if the patient is eligible to enroll;
receiving a policy claim for the event;
evaluating the policy claim, further comprising:
collecting a second set of data including information related to the event; and
providing insurance coverage for the patient if the event is covered by the insurance policy.

2. The method of claim 1, wherein the surgical procedure further comprises a breast augmentation procedure.

3. The method of claim 1, wherein the step of underwriting an insurance policy further comprises utilizing a bimodal distribution curve to determine the coverage benefits and the premium prices for covering the adverse event.

4. The method of claim 2, wherein the step of underwriting an insurance policy further comprises utilizing a Baker rating system of grading capsular contracture to determine the coverage benefits and the premium prices.

5. The method of claim 4, wherein the step of evaluating the policy claim further comprises analyzing whether the health or aesthetic complication related to the event falls under either Grade III or Grade IV of the Baker rating system.

6. The method of claim 2, wherein the step of determining eligibility for enrollment of a patient further comprises providing MRI evaluation coverage and preconditioning the patient to agree to undergo routine MRI evaluations over the period of time.

7. The method of claim 6, wherein the step of determining eligibility for enrollment of a patient further comprises preconditioning the patient to agree to authorize release of MRI evaluation results to a third party.

8. The method of claim 2, wherein the step of providing the insurance policy to the patient if the patient is eligible to enroll further comprises providing a blanket policy to a breast implant manufacturer.

9. The method of claim 1, wherein the step of providing the insurance policy to the patient if the patient is eligible to enroll further comprises providing a policy to a physician providing the procedure.

10. The method of claim 1, wherein the post-operative insurance further comprises complications insurance to cover aesthetic side effects of elective cosmetic surgeries.

11. A method of providing post-operative insurance for a breast augmentation procedure, comprising:
underwriting an insurance policy to cover a health complication resulting from the procedure that may occur from a completion date of the procedure up to least one year from the completion date of the procedure further comprising:
collecting a first set of data including a scope of coverage benefits, a coverage period, and health complication occurrences arising from breast augmentation procedures amongst a group of patients over a period of time,
using computer means to process the first set of data to predetermine premium prices, terms, coverage benefits and exclusions, and
publishing a first report on the premium prices, terms, coverage benefits and exclusions;
determining eligibility for enrollment of a patient undergoing the breast augmentation procedure, further comprising:
collecting personal information on the patient, and
using computer means to process the patient's information against available insurance;
providing the insurance policy to the patient if the patient is eligible to enroll;
receiving a policy claim for the capsular contracture;
evaluating the policy claim, further comprising:
collecting a second set of data including information related to the health complication; and
providing insurance coverage for the patient if the health complication is covered by the insurance policy.

12. The method of claim 11, wherein the health complication comprises a capsular contracture.

13. The method of claim 11, wherein the step of underwriting an insurance policy further comprises utilizing a bimodal distribution curve to determine the coverage benefits and the premium prices for covering the health and aesthetic complication occurrences.

14. The method of claim 12, wherein the step of underwriting an insurance policy further comprises utilizing a Baker rating system of grading capsular contracture to determine the coverage benefits and the premium prices.

15. The method of claim 14, wherein the step of evaluating the policy claim further comprises analyzing whether the capsular contracture falls under either Grade III or Grade IV of the Baker rating system.

16. The method of claim 11, wherein the step of determining eligibility for enrollment of a patient further comprises providing MRI evaluation coverage and preconditioning the patient to agree to undergo routine MRI evaluations over the period of time.

17. The method of claim 16, wherein the step of determining eligibility for enrollment of a patient further comprises preconditioning the patient to agree to authorize release of MRI evaluation results to a third party.

18. The method of claim 11, wherein the post-operative insurance further comprises complications insurance to cover aesthetic side effects of elective cosmetic surgeries.

19. A method of monitoring health and aesthetic complications of a patient post-surgical procedure involving an implantation of a foreign material into a human body in order to maintain the patient's eligibility for continued coverage in a long term insurance policy for the procedure, comprising:
providing MRI evaluation coverage in the long term insurance policy;
preconditioning the patient to agree to undergo routine MRI evaluations over a period of time;
collecting a set of data on the patient's health post-surgical procedure based on routine MRI evaluations over the period of time; and
using computer means to process the set of data to generate a report on the patient's compliance with the required routine MRI evaluations.

20. The method of claim 19, wherein the surgical procedure further comprises a breast augmentation procedure.

21. The method of claim 19, further comprising using computer means to process the set of data to generate a report on the patient's health and aesthetic complications post-surgical procedure over the period of time.

22. The method of claim 19, further comprising preconditioning the patient to agree to authorize release of MRI evaluation results to a third party.

23. A method of determining prices for insurance coverage for a surgical procedure involving implant removal, comprising:
collecting data to measure a historical frequency of implant removal occurrences;
determining a first factor to further determine an increased frequency of the implant removal occurrences when the occurrences paid for by insurance;
determining a second factor to further determine the increased frequency of the implant removal occurrences from a historical time period to an upcoming policy period;
increasing the historical frequency by the first factor and the second factor to further determine the increased frequency of implant removal occurrences when the occurrences are paid for by the insurance;
estimating an average cost of the occurrences;
determining a portion of a premium required for profit and expenses; and
determining a portion of an overall policy price for renewals.

24. The method of claim 23, wherein the step of estimating an average cost of the occurrences further comprises estimating the average cost as a fixed policy benefit.

25. The method of claim 23, wherein the step of estimating an average cost of the occurrences further comprises using computer means to analyze historical data and adjustments for inflation in surgical fees and medical expenses.
